(19) United States
(12) Patent Application Publication
(10) Pub. No.: US 2015/0136868 A1
(43) Pub. Date: May 21, 2015

(54) PRECIPITATION SIMULATOR

(71) Applicant: Julian Eichler, Karlstadt (DE)

(72) Inventor: Julian Eichler, Karlstadt (DE)

(21) Appl. No.: 14/402,167

(22) PCT Filed: May 22, 2013
(86) PCT No.: PCT/DE2013/100187

§ 371 Date: Nov. 19, 2014

(30) Foreign Application Priority Data
May 22, 2012 (DE) 10 2012 010 214.3

(51) Int. Cl. B05B 5/03; B05B 5/08

(52) U.S. Cl. CPC B05B 5/032; B05B 5/087
USPC 239/3; 239/693

(57) ABSTRACT

The invention relates to a precipitation simulator consisting of a collecting area, onto which the precipitants can fall, and a tube, which extends from the lowest point of the collecting area to a transporting device and from there upwards as far as the nozzle, wherein the precipitant can be transported to the upper end of the tube by the transporting device and emerges there, wherein the nozzle is a hollow-body-like rail with outlet openings and wherein either there is an ionization system, consisting of at least one electrode that protrudes into the stream of air/precipitant mixture and/or supplied air and is connected to an alternating voltage of at least 1 kV, and/or the precipitants are provided at least on their surface with an electrically conducting layer.

The invention relates to a precipitation simulator consisting of a collecting area, onto which the bulk-material-like precipitants can fall, and a tube, which extends from the lowest point of the collecting area to a transporting device and from there upwards as far as the nozzle, wherein the precipitant can be transported to the upper end of the tube by the transporting device and emerges there.

In the prior art, precipitation simulators and known in the most diverse areas and application purposes. Their task consists in trickling rain or snow and the like over objects in order to bring about corresponding optical effects, such as are required in conjunction with the presentation of goods on trade show stands, in display windows and the like, but also in film and photo studios. One of the most widespread intentions is to generate a wintery mood with the aid of snow or to represent goods therein. The common feature is that the particles that simulate the precipitation and consist of paper scraps, plastic parts and the like are introduced via a single point above the object area to be snowed on, from where they fall down by the influence of gravity. Here, the particles emerging above the object are either ejected upwards via tubes or discharged downwards via nozzle-like devices in a similar way to a shower head. Only by way of example, we refer to the utility model DE 20 2008 017 823 U1, which describes an open precipitation simulator in which the precipitants, that is to say the particles, are emitted via a punctiform nozzle.

In the application cases frequently found in practice, it is essential to distribute precipitation uniformly over a wide area perpendicular to the angle of view. One of these typical examples is the precipitation simulation at display windows, in which one is confronted with the requirement to ensure uniform snowing over the entire width of the display window. A nozzle-shaped feed of the precipitants cannot fulfil these requirements.

Another fundamental problem in the case of precipitants circulating in a closed circuit is the static charge of the particles forming the precipitants, with the result that this can settle on the pipes and/or exhibits, but also that it can also settle with a more or less uniform layer thickness on the glass panes which surround the exhibits and form a cover, and thereby hinder a desirable free view. In an extreme case, the depositing particles assume such a thickness on the interior sides of the surfaces that they become opaque. The aim, a particularly emphasized presentation of an exhibition due to loosely floating down precipitant, thus turns into the opposite, namely covering or shielding the exhibit from sight. Static charge of the precipitant particles also lead to adhesion and clumping, or even to complete blockage of the pipes, and therefore to complete failure of the system.

Against this background, it is the object of the invention to improve such precipitation simulators such that they permit uniform snowing across a broad front, but also a long-term operating reliability.

This object is achieved according to the invention in that the nozzle is a hollow-body-like rail with outlet openings and in that an ionization system, consisting of at least one electrode is present, which projects into the stream of air/precipitant mixture and/or of supply air and is connected to an alternating voltage of at least 1 kV.

Starting from the more or less punctiform nozzles or pipe ends, which release the precipitant, known in the prior art, a rail is now proposed, which is designed as a hollow body and has a plurality of outlet holes. As a result, the rail permits, in a broad front, which is defined by the centre axis of the rail, a uniform simulation of precipitations. Depending on the performance of the transporting device, a more or less intensive precipitation is then simulated.

Here, the term “precipitant” in the sense of the invention is to be interpreted very generally, since it comprises not only snow, but also the simulation of falling petals or dropping leaves, of hailstones for imitating storms or of sand to achieve a desert character, which all have in common the fact that, thanks to a low specific weight, they can be kept floating for a long time and fall down onto the exhibition objects with no residue, or sink as far as the base by virtue of gravity. In particular the embodiment of the rail as a hollow body, which has the result that the precipitants, which are transported with a comparatively high velocity, are distributed over a large area and thereby undergo a slowing of their velocity, has the result that the electrostatic charge becomes particularly noticeable, particularly in the region of the rail, so that the precipitation particles tend to adhere there and, disadvantageously, also tend to block the circuit there, which becomes unacceptable even if only individual outlet holes are blocked, so that the required uniform snowing perpendicular to the direction of view is interrupted in sections, and is thereby no longer acceptable. For this reason, according to the invention, an electrode is disposed, which projects into the stream of the air/precipitant mixture and/or supply air and to which an alternating voltage of at least 1 kV is applied. This arrangement represents an ionizer, the function of which is to neutralize the static charge of the particles of the precipitant through the ionization of the air, ion voltages of at least 1 kV, in general 20 kV and more, can occur at the tips of the electrodes due to the low radii of curvature, which, due to corona discharges and field emission in their immediate environment, lead to the formation of ions. They, in turn, occur in contact with the precipitants and take on their electrical charge. As is known, the static charge, often also known as contact electricity, occurs in that the materials of different dielectric constants contact one another, which as a consequence of the mutual contact and because of the different mobility of the electrons of the two materials, as are described by the dielectric constants, lead to a different transfer of the electrons in the two directions, so that, as a result, a potential difference builds up. This effect is amplified massively by the movement and the mutual impact of the different materials, and is particularly pronounced if, as is conventional for precipitants, flexible materials come into contact, and intensively conform to one another under the pressure generated by the air stream. In general, the transporting device is formed by a blower, which takes in supply air from the outside, introduces the precipitant into the stream by means of the venturi effect, and from there transports it as far as the outlet tube. It is particularly appropriate, and also particularly expedient that the electrodes for ionization already project into this supply air, so that already ionized air is present in the region of the venturi nozzle. Although possible, it is not absolutely necessary for the electrode to project into the circuit formed by the precipitant.

To eliminate the static charges on the precipitants, a plurality of solutions are conceivable. The use, described in the prior art and above, of an ionization system that essentially eliminates the static charge of the particles by means of an electrode under high voltage has disadvantages. From safety aspects, the need to use high voltages is problematic, requiring, for reasons of occupational safety, corresponding protective measures to be used and high-voltage insulating shielding. These measures are complicated and cannot entirely eliminate the problems that result from high-voltage-carrying supply lines and voltage supplies for occupational safety. For this reason, an alternative is provided by the invention, in which the individual particles of the precipitants, which in their entirety produce the circulating current, are provided on their surface with an electrically conducting layer. Expressly those layer are also comprised that, starting from the surface, also penetrate into the material itself.

The physical mode of operation is as follows: all spatial charges forming by virtue of the friction between two particles are immediately dissipated and neutralized by virtue of the conductivity of the surface. The formation of surface charge is thereby prevented.

As a disadvantage, it could prove that the collisions between the particles or of the particles with the pipe walls serving as guides lead to them undergoing damage on the surface and/or being partially detached so that their function of neutralization of the resulting electrical charges is lost. The finding obtained so far have shown that such a surface adhesion can be readily obtained in that the particles of the precipitant can be used for a full season without impairments. It can be expressly seen that both of the above-describe possibilities for eliminating or suppressing surface charges can also be used and employed simultaneously.

Good results have been obtained with particles in which the conductive layer is applied by adding particular additives during foaming of the particles, which are often made of plastic.

Another possibility for application consists in the fact that the surface application of the electrically conductive layer may be performed by means of a spray. It is to be expected that, in comparison to the aforementioned procedure, the adhesion of this layer to the basic material of the precipitant is lower and thereby higher abrasion is to be expected during practical use.

The precipitation simulator operates as follows: the precipitant which is located on the collecting area is captured at its lowest point by a transporting device and is admitted to the tube. The resulting air/precipitant mixture is blown through a tube to the upper nozzle. In this tube or in the supply air to the transporting device, the ionizer is also installed, which frees the precipitant of its electrostatic charge by means of air ions. The nozzle here is a hollow-body-like rail with outlet holes, which generate a uniform precipitation over the length of the rail. The precipitation elements emerging from the rail then float down to the collection area, where the circulation is completed and continuous work becomes possible.

The supply of the precipitant to the hollow-body-like rail is in principle arbitrary within the scope of the invention, and can be performed either by radial supply across the circumference of the rail but also in an axial direction across the end face thereof. A connection of the tube on the end face of the rail has the advantage that the intrinsic space requirement of the entire device is essentially determined by the radial envelopment of the rail and thus remains minimal. This solution is thus to be preferred in confined installation conditions. With admission to the rails via their end faces, the following regularities occur, depending on the flow conditions: if the precipitant is supplied with comparatively low velocities, that is to say with low pressure of the rail, there is the risk that that the precipitant, seen in the flow direction, precipitates overproportionally in the initial region of the rail and the opposite end of the rail is inadequately supplied with precipitant. On the other hand, with high pressure admission and consequently a high inlet velocity into the rail, the regions close to the beginning, because of the pronounced flow conditions, are only supplied to a slight extent with precipitant, the ends remote from the inlet, on the other hand, experience an overproportional supply of precipitant. Since a uniform snowing over the entire length of the rail is the principle goal, then, due to the above-described effects, only a comparatively narrow useful pressure range, and consequently a comparatively narrow velocity interval is available for use. If one further considers that an adjustment of the intensity of the snowing must be possible within certain limits, it is to be ascertained that, as a result of the above-described flow conditions and the wish for a uniform snowfall over the entire rail length, that is to say due to the de facto usability, there results a maximum length of the rail.

If corresponding to the individual requirement locally, a width is to be snowed on that is greater than the useful length determined by a rail, then problems occur. An essential recognition of the present invention consists in the fact that a solution is to be offered therefor, which consists in mounting a plurality of rails, which are at the same height but are offset with respect to one another in the axial direction By the term “axially offset”, it is meant that the adjacent rails can overlap in sections but also the coaxial arrangement of the rails. The arrangement must take place such that the outlet area, in its entirety, permits a continuous and uniform snowing over the entire front.

It is especially preferred if the axes of the various rails are vertically offset with respect to one another while maintaining the same height. The decisive advantage can be seen in that fact that, with an axial admission to the rails, a problem-free individual supply of the precipitant is possible. Since the various rails are to be arranged at the same height, a step-like arrangement of the rails is obtained in top view.

As a measure for adjusting and regulating the precipitation conditions, the arrangement of a flow detector is provided, by means of which a diaphragm in the stream of the air/precipitant mixture is actuated. Fluctuations occurring due to external influences of any kind are compensated by these measures.

It is particularly preferred to arrange the diaphragm in the supply of the precipitant to the transporting device, since, due to a measure of this kind, the existing flow conditions would not be directly influenced, as they otherwise would be in the case in which they are positioned within the tubes, which would lead to partial backflow.

The design of the electrode of the ionizer is arbitrary within wide limits. It is preferred to design the electrode as a needle, the tip of which projects into the air/precipitant mixture, and the surface of which is smoothed and/or electrically insulated; the latter is to ensure that the high field intensities only act on the precipitant mixture and that no flashovers can occur to the fastening and to the surrounding housings. As regards the high electrical field intensities and consequently the formation of spark flashovers, an arrangement of this kind proves appropriate.

An increase of the ionisation effect is obtained if, a plurality of the needles forming an electrode in each case are arranged parallel to and at a distance from one another. This leads to an amplification and a multiplication of the ionization effect.

The term transporting device comprises all the devices that are capable of moving and rotating the air/precipitant mixture and which keep the circulation formed by the precipitant in movement. As the equipment appropriate for this, blowers are suitable, which transport the precipitant upwards from the base by means of superatmospheric pressure. Similarly, their use as a suction device is conceivable, which, mounted in the ceiling area, generates a subatmospheric pressure and in this manner transports the precipitation material to the ceiling. The use of a suction device would have the decisive advantage that, without significant additional construction outlay, the material can be sucked in at a plurality of points of the base surface. A suction device permits an arbitrary number of base points to be subjected to subatmospheric pressure. If, on the other hand, superatmospheric pressure is used, a separate blower would have to be mounted at every base point. This means a considerable additional constructional outlay and consequently is also made more expensive.

It is basically unimportant in what manner the precipitant is introduced into the air stream. The manner of this admixture is ultimately of secondary importance for the gist of the invention.

For introduction of the precipitant into the air circuit, as an elegant solution, the use of the venturi effect is proposed as advantageous, which utilises the effect that taperings in an air stream lead to an increase of the flow velocity because of the continuity condition, and consequently, as can be derived from the Bernouilli equation, result in a depression of the static pressure. With the aid of a suitable supply means, this can be used for the suction of the precipitant into the stream. The accumulated precipitant, which has already been used for snowing, is collected and sucked up with the subatmospheric pressure generated by the venturi effect, and fed back to the air stream again. An increase of the flow velocity, which is adjustable by means of the transporting device, then also results in an automatic increase of the introduction of the precipitant. The desired effect is that, at a higher flow velocity, a higher precipitant amount is introduced and the particle density of the precipitant in the air stream shows comparatively low fluctuations.

In the specific embodiment of the proposed precipitation simulation, it is basically free whether the entire system is surrounded by transparent panes on all sides, so that, as a result, a closed system is formed, with the advantage that, on one hand, an undesirable escape of the precipitant into the environment is prevented, but on the other hand, external influences are also eliminated, or whether it is an open system that it thus not delimited on all sides by panes. The latter embodiment also comprises those cases in which only individual sides are delimited. An at least partly open design is necessary when, for studio recordings or theatre performances, actors are to enter into the region of the precipitation and stay there.

In dependence on the specific choice of precipitant, there may be pattering noised during operation, of such intensity that their suppression is desirable. One of the measures may consist in applying sound insulating material on the inner or outer wall of the tube and/or rail. The materials that can be used for this are diverse, and, for example, may consist of a felt layer.

Besides the above-described measure of mounting an ionizer, a clumping or even setting of the precipitant within the tube can be further reduced by means of the additional measure by making the tube itself from antistatic material, so that the formation of the charge is greatly reduced. However, this measure is naturally not effective outside the tubes, that is to say in those regions in which the precipitant falls freely. Here, friction of the individual particles against one another is still present so that, in the entirety of the circuit, a static charge cannot be entirely avoided by this proposed measure.

The constructional design of the rail, provided it can fulfil the required function, is arbitrary within wide limits. This also applies for the constructional design of the outlet openings, in which it is preferred to design these as nozzles or as a slit. A prerequisite per se is that the diameter of the precipitant is to be taken into account and determines that the clear width of the outlet openings is chosen such that it is far larger.

An adjustment or homogenization of the distribution of the precipitant emerging from a single rail can also be influenced or even adjusted if distribution baffles/impact baffles are mounted within the hollow-body-like rail. Their adjustability permits influencing after successful installation.

As explained above, the choice of precipitant is arbitrary within wide limits and in dependence on the purpose pursued. However, the use of Styrofoam particles as precipitant is preferred, which is especially suitable for imitating falling snow flakes. The effect often occurring here of static charging is eliminated by the ionizer.

With respect to the development of the collection area and the necessity thereof to collect the precipitant, on one hand, and, on the other hand, to feed it back to the circuit again, it is recommended to use a funnel, the lowest point of which may be connected to the venturi nozzle with the interposition of a displaceable diaphragm. The movement of the precipitant takes place here under the influence of gravity.

Despite the individual measures described, it is not ruled out that the precipitant, in the region of the collection area and possibly also of the diaphragm, agglomerates or clumps together. This would have negative influences on the controllability of the circuit formed by the precipitant, which in an extreme case could lead to blockage.

In practice, it has been found that, with an inclination of the collection area by at least 25°, the precipitant can automatically move as far as the lowest point. The steeper the gradient, the more pronounced the movement of the precipitant towards the lowest point becomes. With this measure, it proves disadvantageous that the base region of the precipitation simulator, the purpose of which is to completely cover this collection area as seen from the side, becomes higher the steeper the gradient is. This would also have the consequence that the display window cannot be used at the bottom as far as the standing surface of the precipitation simulator on the base. If the gradient were to be chosen correspondingly lower, however, the required construction height would be reduced, however the automatic movement of the particles would be hindered. As a solution to this problem, it is proposed that, from one or more sides, approximately tangentially to the collection area, air is blown in via nozzles in such a direction that the particles collect at the lowest point. One measure could consist in introducing air from the end face. An alternative measure consists in the fact that, in the area of the entire collection area in the base area, admission of the precipitant takes place through the laying of perforated tubes. In an alternative, openings could be introduced in the collection area, with pressure application taking place from the opposite side. It would also be conceivable to use kind of windscreen wiper mechanism to move the precipitant that is located on the collection area towards the lowest point, where it can be capture by the transporting device.

In a particularly preferred embodiment, the collection area consists of an essentially horizontally extending plane and, on one end face thereof, of a trough-shaped depression, which represents the lowest point for collection of the precipitant. On the opposite end face is an air-inlet nozzle, via which an air stream is generated essentially tangentially to the flat region of the collection area and an air stream directed towards the lowest point. Above the flat collection area, oblique lamellae are arranged in a grid shape at a distance therefrom, which are oriented such that the cross-section presented to the inflowing air stream tapers in the flow direction. These lamellae ensure essentially that the air strip extends essentially tangentially over the entire collection area and along the surface thereof. The result is that the precipitant moves from the inlet nozzle to the opposite side of the collection area, where the lowest point is located and the precipitant is supplied to the circuit. Within the scope of the invention it is herein immaterial whether the individual lamella extends over the entire width of the collection area or else only over a particular width, so that, in its entirety, a scale-like grid-shaped structure results. The supply of the tangential air stream can take place via a single nozzle. At the same time it is conceivable that a plurality of inlet nozzles, which have a clearance in the flow direction, generate the tangential air stream. From a functional aspect, it is a matter of generating a tangential air stream that sweeps over the entire flat portion of the collection area and is guided by means of lamellae. The precipitation particles occurring essentially vertically on the individual lamellae are deflected and pass, essentially at an acute angle, into the tangential air stream, which transports them to the collection point.

In a further measure, it is proposed as particularly expedient to connect the collection area and/or the diaphragm to a vibrator, which, if necessary, permits the accumulations of the precipitant to be loosened by vibrations and removed.

Finally, the transporting device, which is generally a blower, should be chosen such that its noise emission remains minimal and nevertheless permits a high pressure at a high transporting volume to be realized. High noise emissions could be regarded as annoying by the observer.

In a particularly preferred embodiment, it is provided to make the precipitation simulator modular over its entire width, that is to say that two or more modules of identical construction are placed side by side and connected to one another. The term “side by side” means an arrangement of adjacent modules such that they are directly connected to one another or else that a slight clearance exists, which is covered by optical bridging measures. It is crucial that the individual modules are identical and independent of one another, which, for production, has the advantage that only a single part, namely the module, is to be prepared, with the possibility of allowing different widths of the precipitation simulation to be prepared in situ.

Hereby, the adjacent modules are connected together in series, so that the precipitants in the collection area of the first module are transported with the aid of the transporting device to the hollow-article-like rail with the outlet openings in the adjacent module. From there, the precipitants passes into the collection area of the same module and, from them, in the above-described manner, are brought to the next module. When they reach the last module, in the transportation direction, the precipitants are supplied back to the first module via the transporting device. As a result, a circuit of the precipitant is obtained, in which all modules that are connected one behind the other are encompassed. This arrangement has the decisive advantage that this series connection of the modules ensures that different filling levels cannot occur in the individual modules.

In principle, it is conceivable that the individual modules are self-sufficient in each case, that is to say that the precipitants always remain in the same module. Here, there is the risk that after a relatively long operating time, the filling level of each module adjusts to a different value. The causes of this can occur in the unavoidable intersections of the precipitants at adjacent modules, namely when the amount of precipitant passes in a larger proportion from one module to the adjacent module than is the case in the reverse direction, so that, as a result, an increase or decrease of the filling level occurs. Another cause of this is the deviations of the individual modules due to manufacturing and installation tolerances. In such a case, it is expedient to measure the filling level of each module and to optimally adjust the circulating stream of precipitant again by corresponding control of the transporting device.

The measurement of the filling level is also advisable if the modules are connected in series, because, due to appropriate actuation of the transporting device, it can be achieved that the filling level of each module is essentially the same. The actuation should take place such that, with a low filling level, the performance of the transporting device supplying the particles is increased, likewise in the reverse case, that is to say with too high a filling level, the precipitant from this module it transported away to a greater extent, that is to say with a performance increase of the transporting device.

A decisive advantage of the modular construction consists in the fact that the links between the modules can be achieved simply and without problems by replugging of supply tubes. Finally, in a further embodiment, it is provided to provide a control of the transporting device for the precipitant, which picks up its input signals from the space outside the precipitation simulator. The optical effect on the user is then greatest when the precipitation simulator behaves diametrically to the situation in the “outside world”. When it is snowing outside, it is usually uninteresting also to activate the precipitation simulator. On the other hand, when there is no snowfall outside, the precipitation simulator should be activated as a snowing system. The actuation should therefore be diametrically opposed to the external conditions.

It can also be provided, by means of the control units, that during different phases of operation, the precipitation density is changed, that is to say increased or decreased. This measure counteracts a growing monotony, which would be the case with constant precipitation density.

In principle, there it is possible to walk through the precipitation simulator and thereby the precipitation front. Mounting of sensors could register those regions in which persons are about to walk through the precipitation front, transmit these signals of the sensors to the control unit, in order, at those points where the walking through takes place, to attenuate the intensity of the snowing, or even interrupt it altogether. The person walking through the precipitation simulator could be so situated as to not be struck at all, or only to a minor extent, by the precipitant.

Finally, it is further provided that blowers are used at specific points, which in their direction of action, aim at the precipitation zone, that is to say at that region that extends between the collection area and the hollow-body-like rail with the outlet openings. As a result, in the individual regions between the outlet openings and the collection area, non-uniform movement paths of the precipitants are obtained, that is to say a movement path that not only runs directly from top to bottom but circularly or obliquely or turbulently. As a result, an approximation to the appearance of natural snowfall is obtained. Further details, features and advantages of the invention can be taken from the following descriptive part, in which an exemplary embodiment of the invention is explained with reference to a drawing. wherein:

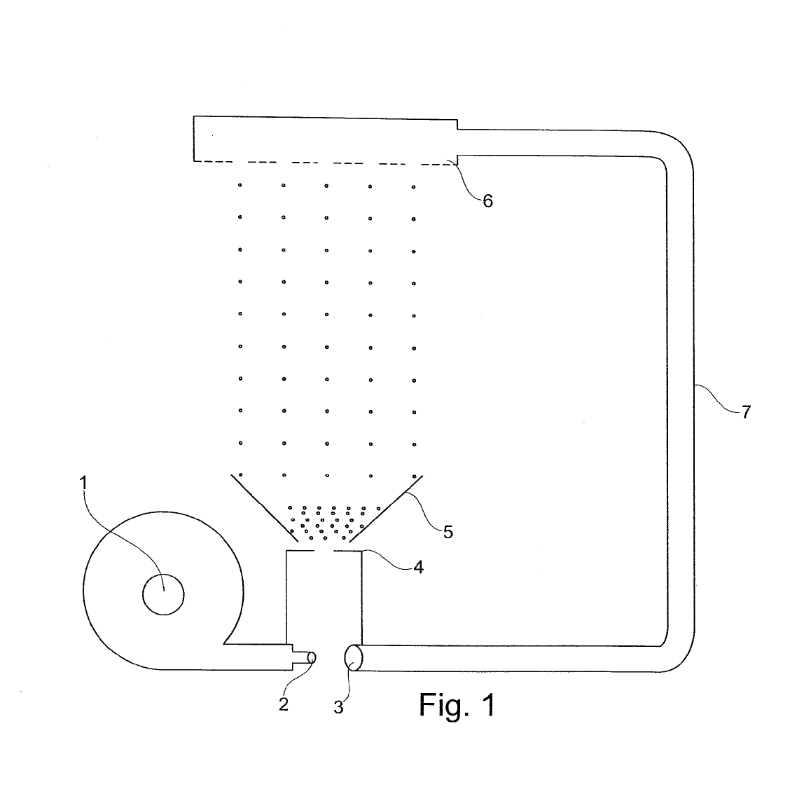

FIG. 1 shows a schematic representation of an arrangement according to the invention in side view,

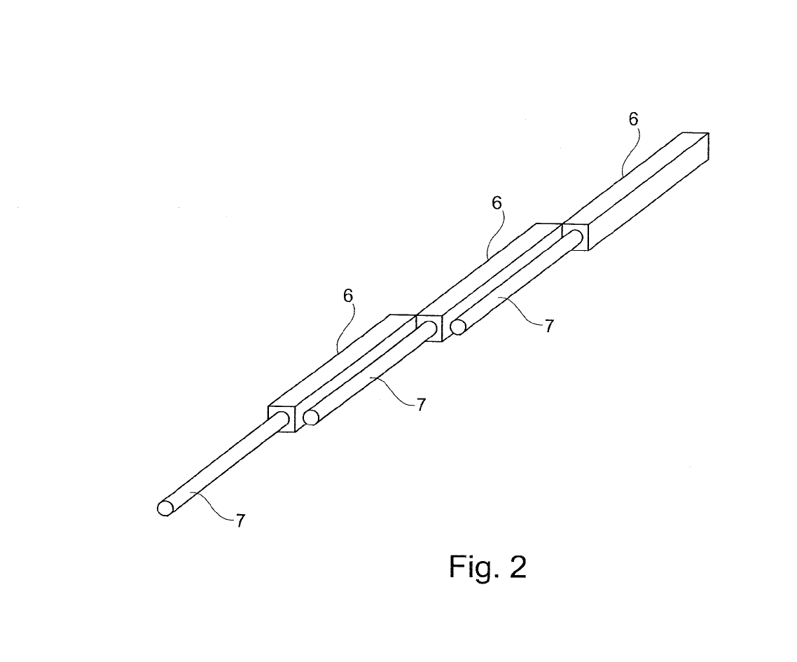

FIG. 2 shows a detail view of a plurality of rails.

The described circuit is operated via the blower 1, which can be adjusted in its performance to a certain extent. Starting from the blower 1, the air stream next passes through the venturi nozzle 2, where a static subatmospheric pressure develops because of the constriction of the flow cross-section. This subatmospheric pressure, in turn, is used to suck the supplied precipitant from above and thereby introduce it into the air stream. In the flow direction, the flow detector 3 follows next, which is simultaneously positioned in the inlet region of the tube 7. The tube 7 leads the mixture of air/precipitant in an arcuate path upwardly, in order to supply it there to a hollow-article-like rail 6. It is indicated that the displayed arrangement consists of at least three rails, which are at the same height, but, in the direction of view of the observer and therefore perpendicular to the plane of the drawing, are therefore offset while maintaining a coaxial orientation. De facto, three individual rails are obtained, the feed to the two left-hand rails that are to be offset rearwardly being concealed because of the perspective of view. On their underside, the outlet openings in the rail can be seen.

From there, the precipitant rains down under the influence of gravity, where it collects in collection area 5, which is designed in the manner of a funnel, and is supplied to the lowest point. There, a diaphragm 4, of which the setting can be varied, is located.

A control loop is formed from the flow detector 3, which is used as signal transmitter and the diaphragm 4, in the sense that, with a corresponding enlargement of the passage cross-section more precipitant is sucked in by means of the venturi effect and supplied to the flow circuit. Vice versa, a reduction of the diaphragm opening leads to a lower introduction of the precipitant in the flow circuit, so that the circulating mixture becomes depleted.

In FIG. 2, the described arrangement of the rails 6 in the upper region of the snowing system, but also their supply via tube 7 is shown by means of a sectional view and a backward oblique view. It can be seen that the individual rails are displaced in an axial direction and disposed at the same height, however are offset in a step-like manner in a radial direction. Because of the comparatively small radial diameter of the rails 6, the offset of the rails 6, with respect to one another, cannot be seen from the direction of view of the viewer. Here, admission to each rail takes place via an own tube 7.

By virtue of the partial view, the further elements of the precipitation simulator, as can be derived from FIG. 1, are not shown.

### LIST OF REFERENCE SIGNS

1 Blower
2 Venturi nozzle
3 Flow detector
4 Diaphragm
5 Collection area
6 Hollow-body-like rail
7 Tube

1. Precipitation simulator consisting of a collecting area, onto which the bulk-material-like precipitants can fall, and a tube, which extends from the lowest point of the collecting area to a transporting device and from there upwards as far as the nozzle, wherein the precipitant can be transported to the upper end of the tube by the transporting device and emerges there, wherein the nozzle is a hollow-body-like rail with outlet openings and in that either an ionization system, consisting of at least one electrode is present, which projects into the stream of air/precipitant mixture and/or of supply air and is connected to an alternating voltage of at least 1 kV and/or the precipitants are provided, at least on their surface, with an electrically conducting layer.

2. Precipitation simulator according to claim 1, wherein a plurality of rails are mounted such that they are offset in an axial direction.

3. Precipitation simulator according to claim 2, wherein the axes of the rails are offset with respect to one another perpendicular to the axis.

4. Precipitation simulator according to claim 1, wherein a flow detector is disposed, which actuates a diaphragm in the flow of the air/precipitant mixture.

5. Precipitation simulator according to claim 1, wherein a flow detector is disposed, which actuates a diaphragm in the supply of the precipitant to the transporting device.

6. Precipitation simulator according to claim 1 wherein the electrode has the form of a needle, of which the tip projects into the air/precipitation element mixture and of which the remaining surface is smoothed or electrically insulated.

7. Precipitation simulator according to claim 6, wherein a plurality of needle-like electrodes are disposed such that they are parallel and have a clearance from one another.

8. Precipitation simulator according to claim 1, wherein the transporting device is a blower, which operates with superatmospheric pressure and is disposed in the base area and/or operates with subatmospheric pressure and is disposed in the ceiling area.

9. Precipitation simulator according to claim 1, wherein the precipitant can be introduced into the air circulation via a tapering in the tube (venturi effect).

10. Precipitation simulator according claim 1, wherein the entire system is partitioned off by means of transparent panes, that is to say represents a closed system.

11. Precipitation simulator according to claim 1, wherein the system is open, that is to say is not delimited on all four sides, for example by means of panes.

12. Precipitation simulator according to claim 1, wherein, on the inner or outer wall of the tube and/or rail, sound insulation material is applied.

13. Precipitation simulator according to claim 1, wherein the tubes have a wall of antistatic material.

14. Precipitation simulator according claim 1, wherein the outlet openings take the form of nozzles and/or slits.

15. Precipitation simulator according to claim 1, wherein, distribution baffles/impact baffles, which can be adjustable, are mounted in the hollow-body-like rails.

16. Precipitation simulator according to claim 1, wherein the precipitation elements are made of Styrofoam.

17. Precipitation simulator according to claim 1, wherein air can be admitted to the collection area at the surface thereof such that the precipitants accumulate at the lowest point.

18. Precipitation simulator according to claim 17, wherein the air is directed tangentially to the collection area and/or is emitted by laying of and admission to perforated tubes on the collection area and/or by means of openings in the collection area, to which air is admitted from the underside.

19. Precipitation simulator according to claim 1, comprising a windscreen wiper sweeping the collection area, which transports the precipitant to the lowest point.

20. Precipitation simulator according to claim 1, wherein the collection area is designed essentially as a horizontally extending plane and otherwise as a trough-like depression forming the lowest point, and air is admitted to the collection area tangentially from the end face that lies opposite the depression and towards the depression, and, above the collection area and with a clearance therefrom, lamellae which are obliquely oriented in a grid, are disposed and oriented such that the cross-section presented to the incoming air tapers in the flow direction.

21. Precipitation simulator according to claim 1, wherein the collection area is a funnel, which, at its lowest point, opens into the venturi nozzle.

22. Precipitation simulator according to claim 1, wherein the collection area and/or the diaphragm is connected to a vibrator.

23. Precipitation simulator according to claim 1, wherein the transporting device is chosen such that, with low noise emission, high pressures with a high transportation volume can be set.

24. Precipitation simulator according to claim 1, wherein the precipitation simulator consists of a plurality of identical components, the modules, which are set up such that they are disposed side by side.

25. Precipitation simulator according to claim 24, wherein the modules are connected in series.

26. Precipitation simulator according to claim 24, wherein the filling level of the module is measured and, if it departs from the filling level of adjacent modules, the transporting device is actuated with the aim of adjusting it.

27. Precipitation simulator according to claim 1, wherein the precipitation situation is registered outside the precipitation simulator and the actuation of the transporting device takes place such that the precipitation simulator is actuated in diametrical opposition to the exterior space.

28. Precipitation simulator according to claim 1, wherein the precipitation density can be differently set in a phased manner by means of the performance of the transporting device.

29. Precipitation simulator according to claim 1, wherein, in the region of the precipitation simulator, sensors are mounted, which, on registering persons, attenuate or completely interrupt the precipitation performance at least in the registered region.

30. Precipitation sensor according to claim 1, wherein further blowers are provided, of which their direction of action is aimed at the space between the collecting area and hollow-body-like rails with the outlet openings.

31. Method for producing the precipitant according to claim 1, wherein, in the manufacture of the particles made of plastic, a conductivity-imparting additive is admixed and/or the electrically conducting layer is sprayed onto the precipitants.
